(19) United States
(12) Patent Application Publication
(10) Pub. No.: US 2025/0238679 A1
(43) Pub. Date: Jul. 24, 2025

(54) Methods and Systems for Determining and Providing Actionable Feedback Related to Results Derived Through Synaptic Intelligence

(71) Applicant: Nara Logics, Inc., Boston, MA (US)

(72) Inventors: Nathan R. WILSON, Belmont, MA (US); Jana B. EGGERS, Boston, MA (US); Snejana SHEGHEVA, Lowell, MA (US); Evan Favermann EISERT, Somerville, MA (US); Jared SEGAL, Quincy, MA (US); Hannah BURK, Longmont, CO (US)

(21) Appl. No.: 18/421,488

(22) Filed: Jan. 24, 2024

(51) Int. Cl. G06N 3/091

(52) U.S. Cl. CPC G06N 3/091

(57) ABSTRACT

In an illustrative embodiment, systems and methods for generating reasoning related to request results obtained via a synaptic neural network include activating, within the synaptic neural network, an input vector representing attribute(s) related to a request, gathering candidate information characterizing candidate nodes and reasoning information characterizing property value nodes explored by the neural network in reaching at least certain candidate nodes. The reasoning information may include nodal values of a matched portion of the property value nodes and/or nodal values of an unmatched portion of the property value nodes. Results information representing one or more result nodes and corresponding reasoning information may be formatted for review by an end user.

### RELATED APPLICATIONS

This application is related to the following patents and their corresponding families of filings by Nara Logics, Inc.: U.S. Pat. No. 11,727,249, entitled “Methods for Constructing and Applying Synaptic Networks,” issued Aug. 15, 2023; and U.S. Pat. No. 11,651,412, entitled “Systems and Methods for Providing Recommendations based on Collaborative and/or Content-Based Nodal Interrelationships,” issued May 16, 2023. All above identified patents and applications are hereby incorporated by reference in their entireties.

### BACKGROUND

Businesses, governments, and individuals use artificial intelligence to assist in identifying recommendations and solutions. Artificial intelligence systems and algorithms are trained or tuned to cull through large data sets, deriving inferences and associations from the provided materials. Commonly used artificial intelligence systems, however, may provide results that do not match the user's objectives, such as unexpected or undesirable results.

The inventors recognized a need for explainability in results derived through synaptic network-based artificial intelligence to provide users with confidence in the trustworthiness and applicability of the information supplied by the artificial intelligence. Further, the inventors recognized a need to provide a user-friendly feedback path to tune results based on relevance attributed to individual results by the end user.

### SUMMARY OF ILLUSTRATIVE EMBODIMENTS

In one aspect, the present disclosure relates to systems and methods for providing a human-comprehensible explanation for the reasoning behind one or more recommendations provided to the user by synaptic network-based artificial intelligence. The reasoning, for example, may include a human language summary of primary reasons for presenting a recommendation and/or ranking a certain recommendation above other recommendation(s). The summary, for example, may include reasons inferred from data sources and/or data paths followed by the artificial intelligence to derive the result. Further, the summary may include reasons inferred from data sources and/or data paths that were screened, filtered, or demoted from consideration.

In some embodiments, the reasoning includes multi-level explanations. For example, a highest level of explanation may capture overall insights, while lower levels of explanation may be used for diagnosing the reasoning behind unanticipated or undesirable results and/or understanding the motivation behind more individual outcomes (e.g., individual recommendations of a set of recommendations).

In one aspect, the present disclosure relates to systems and methods for automatically producing reasoning information while gathering results via a synaptic neural network. Responsive to activation of one or more input nodes, during traversal of neural network paths, attributes of property value nodes included in connection paths to one or more candidate nodes may be collected as reasoning information for formatting and publication to an end user to gain insights related to why certain results were returned (or, conversely, not returned).

In some embodiments, the reasoning information includes property value node profiles for each of a set of property value nodes. The property value node profiles may include, in some examples, a property value, a name (e.g., type) and/or corresponding category (group of similar property value node elements) of the property value node, a number of connections to the property value node, and/or one or more weights calculated in analyzing each path via the property value node to one or more candidate nodes.

In some embodiments, the reasoning information includes a set of matched nodes contributing to the analysis leading to the collection of one or more candidate nodes. The matched nodes, for example, may be activated as being at least partially responsive to the input vector.

In some embodiments, the reasoning information includes a set of unmatched nodes that did not contribute to the analysis leading to the collection of one or more candidate nodes. For example, the unmatched nodes may be connected to a candidate node (directly or indirectly) but are not responsive to the factors provided in the input vector.

In one aspect, the present disclosure relates to systems and methods for obtaining end user feedback regarding one or more recommendations provided to the end user by synaptic network-based artificial intelligence. The end user feedback, in some embodiments, can be decomposed into 3 channels: (1) the “activated” channel for giving feedback (e.g., makes sense, does not make sense, etc.) about factors which propelled the Al's recommendation, (2) the “unactivated” channel for giving feedback about which factors were absent from propelling the Al's recommendation that the end user believes should have been considered, and (3) the “unmet” channel for giving feedback about which factors the end user was seeking that certain recommendation(s) fail to address. Each of the above-noted channels of information can steer future recommendations and/or tuning of the synaptic network-based artificial intelligence in distinct ways. Further, the channels of feedback can be used to provide insight into whether one or more data sets are missing from the analysis (e.g., not within the learning materials provided to the synaptic network-based artificial intelligence).

While generally described above in a manner that supports binary (e.g., like vs. don't like) feedback and/or a spectrum (e.g., weighted on a scale from 1 to N, etc.), in some embodiments, multimodal feedback is enabled. Multimodal feedback, for example, may include text-based feedback. The systems and methods described herein, for example, may include a natural language processing mechanism to parse the feedback and determine tuning updates to make to the synaptic network. The tuning updates, for example, may include an adjustment of weights to modify logic flow toward a path not taken and/or away from a path taken.

In some embodiments, feedback may be applied as collaborative updates such that various members of a group of end users may contribute to supplying feedback to a shared synaptic network. The submission of feedback, for example, may be associated with a particular user (e.g., profile, login credentials, etc.) such that feedback received from individual users may be tracked. A feedback submission archive, for example, may be used to trace contributions from the various members of the group. In some implementations, a report may be generated for distribution to a supervisor, the group as a whole, or another end user (e.g., an administrator or super user) for identifying frequency and/or type of feedback submitted by each member of the group. The report, for example, may be generated periodically and/or on a request basis.

The foregoing general description of the illustrative implementations and the following detailed description thereof are merely exemplary aspects of the teachings of this disclosure, and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale.

Any values dimensions illustrated in the accompanying graphs and figures are for illustration purposes only and may or may not represent actual or preferred values or dimensions. Where applicable, some or all features may not be illustrated to assist in the description of underlying features. In the drawings:

FIG. 1 is an operational flow diagram of an example process for determining actionable feedback regarding query results obtained from a synaptic neural network;

FIG. 2A is a diagram of a simplified partial architecture of an example neural network;

FIG. 2B is a table summarizing activity within the example neural network;

FIG. 3 is a flow chart of an example method for performing dynamic clustering of activity within a neural network to gather results along with information regarding the reasons for the results;

FIG. 4A is a screen shot of a first example user interface for interactively reviewing information related to the reasons for providing a particular recommendation;

FIG. 4B is an example graphical user interface illustrating details regarding a particular nodal connection traversed in determining a subject recommendation;

FIG. 4C is a screen shot of a second example user interface for interactively reviewing information related to the reasons for providing a particular recommendation;

FIG. 4D is an example user interface for providing feedback related to a result;

FIG. 5 is a flow chart of an example method for applying feedback received in response to results obtained from a synaptic neural network; and

FIG. 6 is a block diagram of a synaptic neural network-based system for collaboratively tuning a synaptic neural network using feedback obtained from a set of members of a group.

### DETAILED DESCRIPTION OF ILLUSTRATIVE EMBODIMENTS

The description set forth below in connection with the appended drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

It must be noted that, as used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Furthermore, the terms “approximately,” “about,” “proximate,” “minor variation,” and similar terms generally refer to ranges that include the identified value within a margin of 20%, 10% or preferably 5% in certain embodiments, and any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

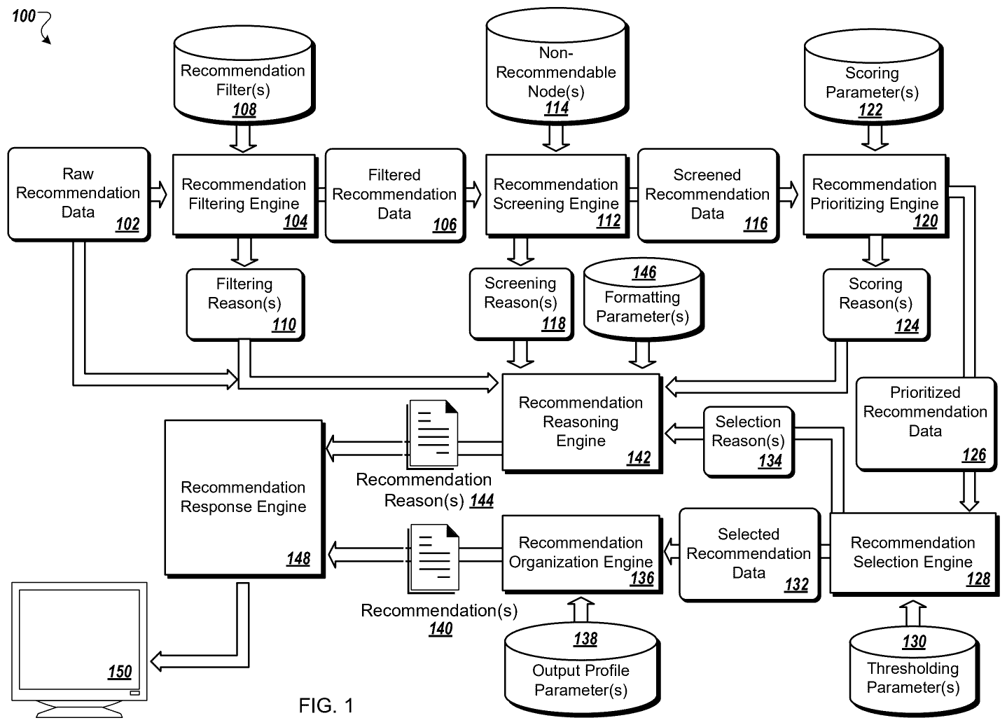

FIG. 1 is an operational flow diagram of an example process 100 for determining actionable feedback regarding query results obtained from a synaptic neural network. The process 100, in some implementations, begins with receiving raw recommendation data 102 including information regarding nodes of the synaptic neural network that an input query activated via path(s) to obtaining each of the recommendations in the raw recommendation data 102. The input query, for example, may include one or more pieces of information (e.g., properties, node types, keywords, etc.) corresponding to a query input by a user. Further, the input query may include information pertaining to the user. In this manner, prior preferences of the user may be activated to refine results in a manner beneficial to the end user. The raw recommendation data 102, for example, may identify types of nodes and the corresponding propert(ies) of a set of nodes activated in traversing a path via the synaptic neural network to each particular result (e.g., recommendation) in addition to a set of recommended results. In the illustrative example of a request for movie recommendations based on user-identified parameters (or the user's favorite movie which, itself, includes a set of parameters), the types of nodes activated may include actor nodes, director nodes, producer nodes, writer nodes, genre nodes, release date nodes, and/or production company nodes. The raw recommendation data 102, for example, may include vector information regarding each node traversed (e.g., property name, property value, category name, weight, number of connections, etc.).

In some implementations, a recommendation filtering engine 104 filters the raw recommendation data 102 to obtain filtered recommendation data 106. The filtering, for example, may be performed based on one or more recommendation filters 108 applicable to the query. The recommendation filters 108, for example, may filter the set of candidate results in the raw recommendation data 102 to only include the requested property type (e.g., a movie, as opposed to a television series, actor, etc.). In another example, filtering can be conducted by adding a threshold to a numerical match score, thereby collecting only those matches within a threshold closeness to the parameters of the request or within a threshold closeness to a best match (e.g., highest score) of the candidate results. Although described in relation to identifying the best candidate matches, in other embodiments, thresholding may be used to identify one or more worst matches (e.g., below a threshold), calculate a count or percentage of candidate results beneath a set threshold, and/or identify matches within a specified absolute or relative range of score (e.g., high and low thresholds).

If the recommendation filtering engine 104 filtered any nodes due to the recommendation filter(s) 108, the recommendation filtering engine 104, in some embodiments, generates one or more filtering reasons 110 (e.g., reasons for removing one or more candidate results from the set of recommendations). The filtering reasons 110, for example, may identify the filtering type (e.g., property type movie) and/or a filtering threshold (e.g., runtime no greater than 3 hours, which may remove a miniseries that is not labeled as a miniseries).

In some implementations, the filtered recommendation data 106 is analyzed by a recommendation screening engine 112 designed to analyze the filtered recommendation data 106 in view of non-recommendable nodes 114 to generate a set of screened recommendation data 116 that may have one or more fewer nodes than the filtered recommendation data 106. In the illustration of movie recommendations, the geography of the user may limit the availability of distribution of certain films such that unavailable films may be screened as non-recommendable nodes. In some embodiments, if one or more nodes have been screened from the filtered recommendation data 106, the recommendation screening engine 112 generates one or more screening reasons 118. In other embodiments, no screening reasons 118 are generated. For example, the non-recommendable nodes 114 may be screened for confidentiality, security, or other factors such that the end user is not meant to be aware of the existence of these nodes. In a further example, the activation dynamics in the network retrieval of at least a portion of the matches may be analyzed to screen out one or more candidate recommendations due to lack of confidence in the path taken to retrieve each screened recommendation.

In some implementations, the screened recommendation data 116 is analyzed by a recommendation prioritizing engine 120 to generate prioritized recommendation data 126 which is ranked or otherwise organized to promote certain recommendations based on one or more scoring parameters 122. In some embodiments, the recommendation prioritizing engine 120 prioritizes results based on one or more weights associated with each result. Further, the recommendation prioritizing engine 120 may take into consideration a recency of various results (e.g., newness of the node within the synaptic neural network) and/or a number of connections between the node and other nodes within the synaptic neural network.

In some implementations, a recommendation selection engine 128 selects at least a portion of the prioritized recommendation data 126 to return as selected results to the requesting system, generating a set of selected recommendation data 132. The recommendation selection engine 128, for example, may apply one or more thresholding parameters 130, such as a limit of a total number of results and/or a threshold confidence value for each selected result. In some embodiments, the recommendation selection engine 128 additionally generates a set of selection reasons 134 corresponding to one or more recommendations that didn't make the cut.

A recommendation organization engine 136, in some implementations, organizes the selected recommendation data 132 according to one or more output profile parameters 138 to provide the results as recommendations 140 arranged in a format suitable for a particular end user and/or end system. The recommendation organization engine 136, for example, may arrange the selected recommendation data 132 for transfer to an end system via an application programming interface (API). In another example, the recommendation organization engine 136 may convert values within the raw vector formatting of the selected recommendation data 132 into recommendations 140 appropriate for consumption via a graphical user interface.

In some implementations, a recommendation reasoning engine 142 accesses raw reasons data captured in the raw recommendation data 102, any filtering reason(s) 110, any screening reason(s) 118, any scoring reason(s) 124, and/or any selection reason(s) 134 and generates recommendation reason(s) 144 corresponding to the recommendation(s) 140. The recommendation reason(s) 144, in some embodiments, is organized according to one or more formatting parameters 146. The formatting parameters 146, for example, may include mechanisms for converting raw vector data to a human readable form for consideration by the requester at a graphical user interface. In another example, the formatting parameters 146 may include parameters for converting the raw recommendation data 102 into a format compatible with an API used by a requesting system.

In some implementations, a recommendation response engine 148 prepares the recommendation(s) 140 and the recommendation reason(s) 144 for receipt and/or review at a requester system 150. The recommendation response engine 148, for example, may generate a graphical user interface for reviewing a list of results and reason information and/or for visualizing the results in a manner that provides a drill-down interactive interface for considering the relative impact of various inputs and activated nodes in surfacing each result or group of results.

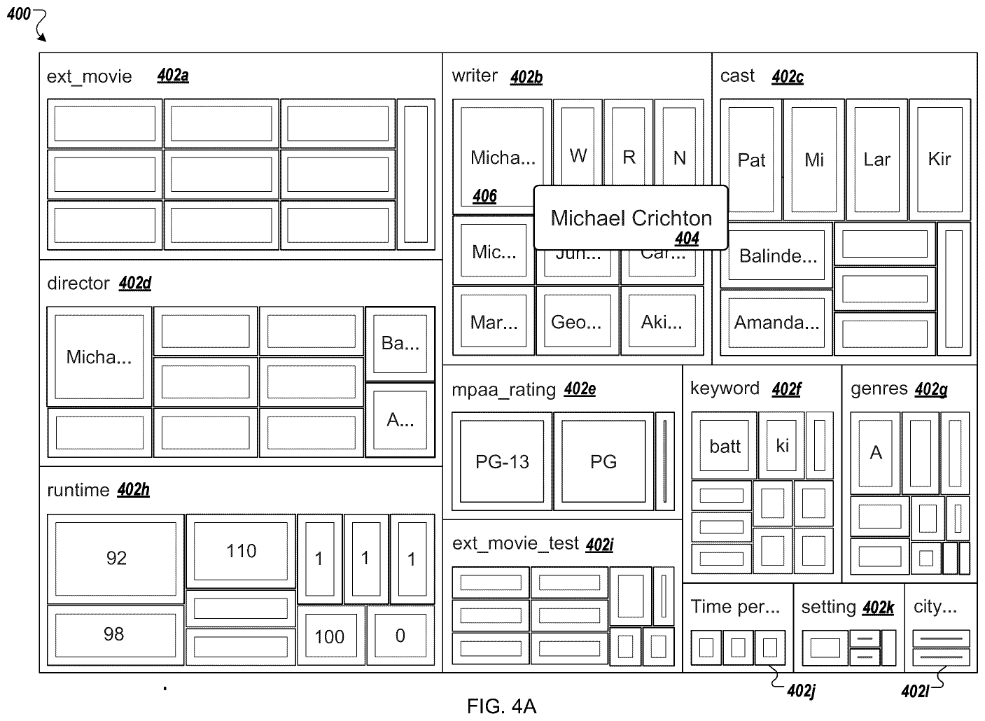

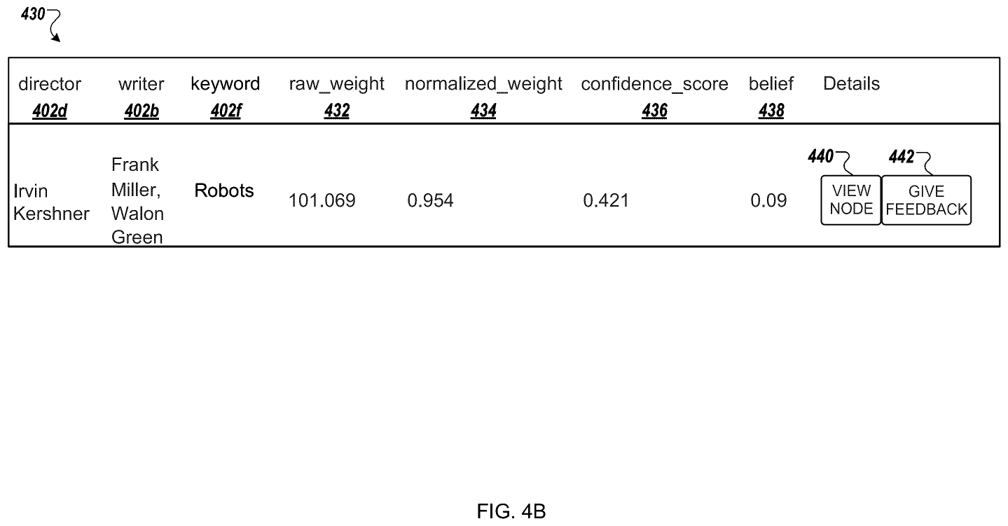

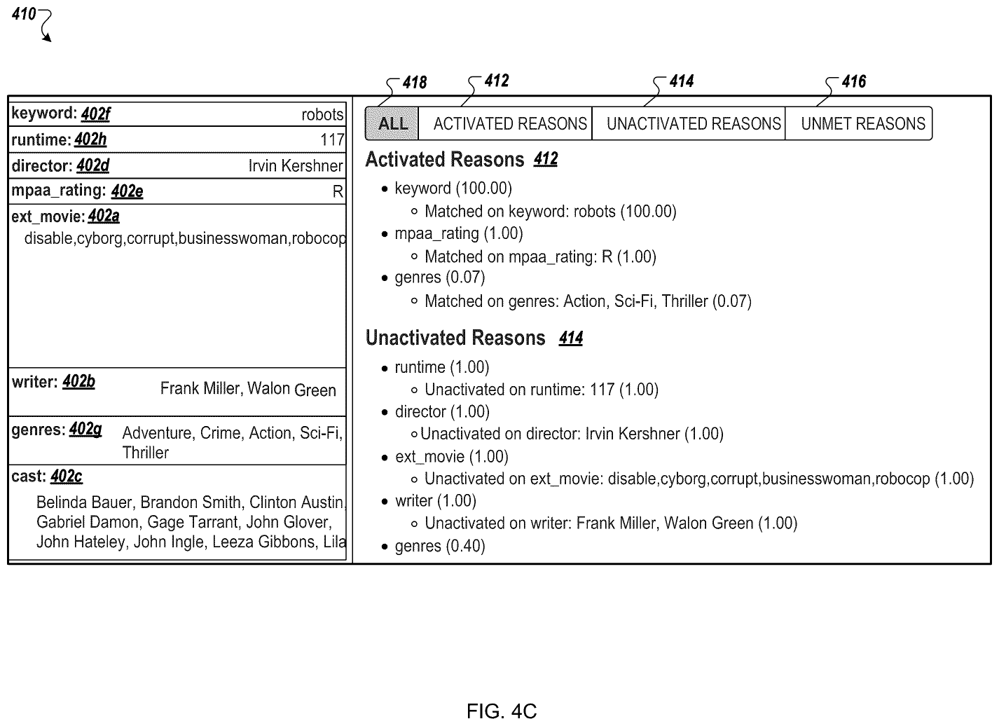

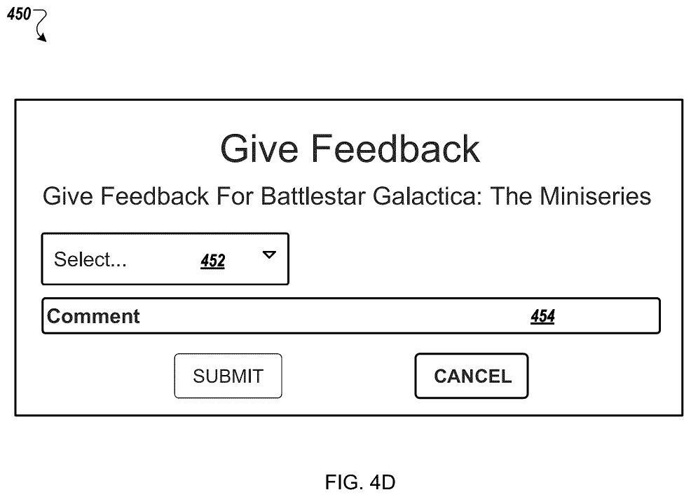

In an illustrative example, turning to FIG. 4A, an example user interface 400 illustrates a treemap diagram including user-selectable drill-down information regarding reasons related to each category of input related to a user request. As illustrated, the treemap diagram of the example user interface 400 presents selectable categories 402a-1 such as, in some examples, writer 402b, cast member 402c, director 402d, genre 402g, and rating 402e. Each category, in turn, includes a set of boxes identifying particular items (e.g., nodes) reached during traversal of the synaptic neural network to identify one or more movie recommendations. For example, as illustrated, writer “Michael Crichton” 404 appears layered on top of the set of writers in the writer category 402b, for example due to the user hovering over an associated box 406 of the writer category 402b. The treemap diagram, for example, provides the end user with the opportunity to interactively explore factors and sub-factors associated with the results provided by the synaptic neural network platform. Further, in selecting more detailed information, weights and/or other metadata (e.g., context, contextual cues, user preferences, historical parameters, etc.) may be presented to the user. Although described in relation to a treemap diagram, in further examples, similar interactive layers of drill-down information can be presented to a user in a graphical presentation including an interactive graph network, word cloud, and/or tree diagram.

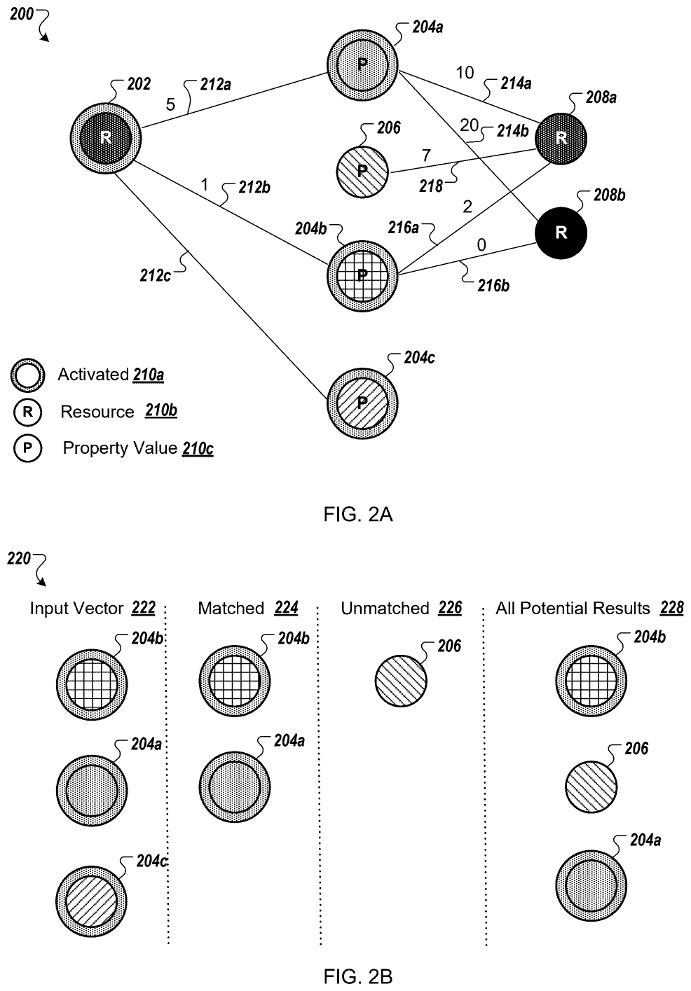

In drilling down into the treemap diagram of the user interface 400, for example, the user may be presented with an example graphical user interface 430 of FIG. 4B illustrating details regarding a particular nodal connection traversed in determining a subject recommendation (e.g., RoboCop 2). As illustrated, the example user interface 430 presents metrics related to a connection between director Irvin Kershner and writers Frank Miller & Walon Green as well as a keyword 402f of “robots.” The metrics include a raw weight 432 of 101.069, a normalized weight 434 of 0.954, a confidence score 436 of 0.421, and a belief 438 of 0.09. Calculations of the weights are described below in relation to FIG. 2A and FIG. 2B. The confidence score 436 represents a likelihood of the input node (e.g., director 402d) representing a match based on the writer 402b value and the keyword 402f value. Further, the belief 438 represents a vector across the contributing nodes' metrics (e.g., normalized scores) to calculate a probability distribution for the returned matching results. This represents how well one result node matches in comparison to the match of the entire set of result nodes. This, in turn, takes into account how well the other result nodes of the set match the input signal. A lower belief value corresponds to a better match across the other recommended nodes to the input node. In other words, the belief 438 metric provides the viewer with an idea of whether the subject match is superior in matching in comparison to other nodes (e.g., a clear best result).

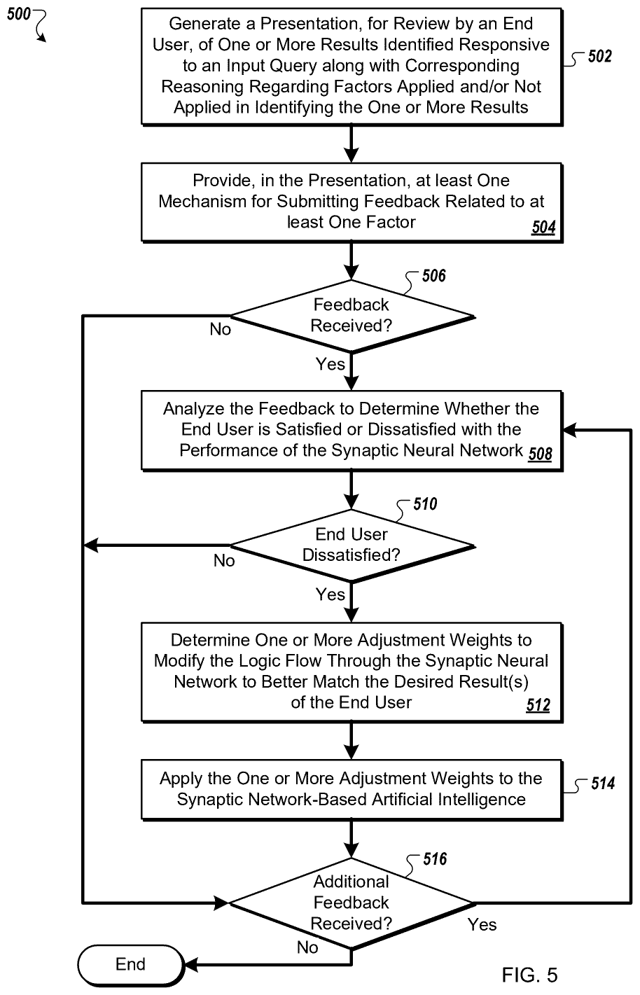

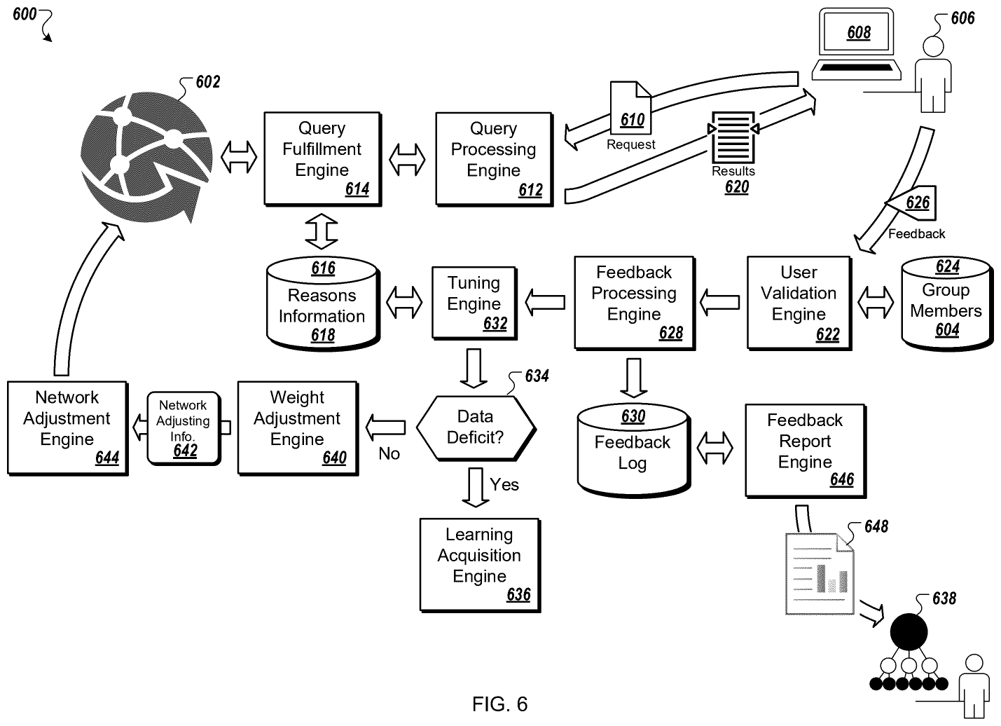

The user interface 430 includes a set of controls 440, 442 to obtain additional information. Upon selecting the view node control 440, for example, information regarding the present node (e.g., name, metadata, metrics, etc.) may be presented. Upon selecting the give feedback control 442, a user may be presented with the opportunity to provide the system with an assessment regarding the value of the subject match. The assessment, in some examples, may represent a binary (e.g., good/bad), a range of values (e.g., very helpful, helpful, not helpful, misleading), and/or an opportunity to submit written feedback related to the match. Further discussion regarding feedback is presented below in relation to FIG. 4D, FIG. 5, and FIG. 6.

Turning to FIG. 4C, a second example user interface 410 presents a user with reasons applied by a synaptic neural network platform in recommending the movie RoboCop 2. As illustrated, some of the same categories 402 presented in the user interface 400 of FIG. 4A are provided at the left side of the user interface 410, each category 402 presented including a value applicable to the movie RoboCop 2. In illustration, for the keyword category 402f, the keyword “robots” is presented, and for the category genres 402g, the genres of adventure, crime, action, sci-fi, and thriller are provided.

To the right, both activated 412 and unactivated 414 reasons are presented for user review (e.g., based on selecting an “All” tab 418 for the present view). The activated reasons 412 represent reasons for recommending the movie RoboCop 2 (e.g., keyword 402f matched to robots, rating 402e of R, and genres 402g of action, sci-fi, and thriller). The unactivated reasons 414 represent information related to RoboCop 2 that was not matched on and/or relied upon for forming the recommendation decision. In some examples, a runtime 402h of 117 minutes, director 402d of Irvin Kershner, and writer 402b of Frank Miller and Walon Green were not considered (e.g., categories not traversed) to reach the result of RoboCop 2 and/or the factors were filtered out or otherwise discarded. The unactivated reasons 414, for example, may include characteristics not included in a user request.

In some implementations, the reasons include one or more unmet reasons 416 representing unknown information that may have been useful in coming to a recommendation decision. The unknown information, in some examples, may include a category having no value available for the movie RoboCop 2 (e.g., no details regarding the settings category 402k of FIG. 4A may have been collected by the synaptic neural network) or a category of information that the synaptic neural network lacks (e.g., information regarding a Rotten Tomatoes rating by Warner Bros. Discovery and NBCUniversal), which was referenced and/or inferred from the user request.

The recommendation reason(s) 144 of FIG. 1, in some embodiments, map particular attributes of each recommended item based on a path taken to select the item (e.g., a path via the particular attribute). Turning to FIG. 2A and FIG. 2B, a simplified diagram of a portion of a synaptic neural network 200 illustrates an example neural network path traversed based on activation (210a) of a resource (210b) node 202. The resource node 202 connects to three property value 210c nodes 204a, 204b, and 204c. The property values, for example, may be considered attributes or descriptors of the resource node 202 (e.g., the adjectives, classifications, etc.). By activating the property value nodes 204a-c via the resource node 202 (e.g., activating an input vector 222), resource node 208a and resource node 208b are reached. For example, resource node 208a and resource node 208b each share both property value 204a and property value 204b with resource node 202 (e.g., the property values 204a and 204b are matched 224). Property node 208b indirectly leads to property value node 206 (e.g., via a connection 218), which renders it considered in the matching of the resource node 202. However, without further connections leading from the property value node 206, property value node 206 is considered to be unmatched 226.

Thus, in a reasons table 220, both attempted matches (e.g., property value nodes 204a-c of the input vector 222 as well as the unmatched 226 but indirectly accessed property value node 206) as well as positive matches 224 (e.g., property value nodes 204a and 204b) are presented. In combination, all potential results 228 are identified in a final column. This information may be used in whole or in part to form the basis for the recommendation reasons 144 of FIG. 1. For example, identifying the matches allows the user to identify one or more properties that are actually not considered to be strongly related to the resource node 202 and/or other aspects of an input query. In a further example, identifying the unmatched 226 property value 206 could provide visibility into an aspect of information that may be presently lacking or sparsely populated in the neural network. In illustration, the race or nationality of authors of works may be limited or lacking in a neural network matching media (e.g., music, video, literature) with consumers.

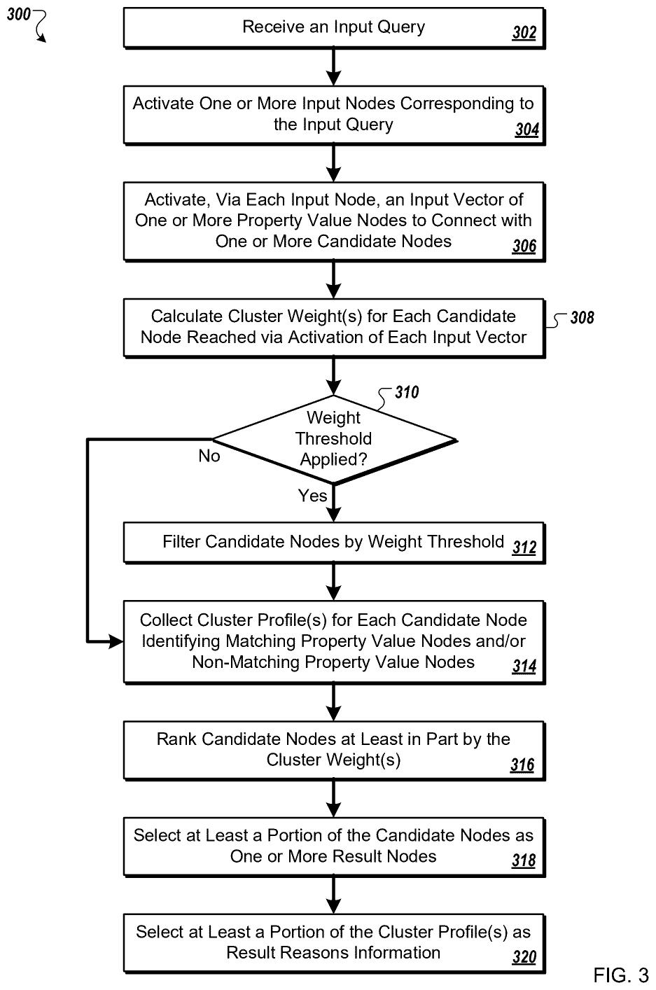

FIG. 3 illustrates a flow chart of an example method 300 for identifying results and reasons for the results responsive to a user request submitted to a neural network. A portion of the method 300, for example, may be performed by the recommendation filtering engine 104, the recommendation screening engine 112, the recommendation prioritizing engine 120, and/or the recommendation selection engine 128 of FIG. 1.

In some implementations, the method 300 begins with receiving an input query to a neural network (302). The input query, in some embodiments, is submitted by a user via a user interface. The input query may include one or more words, graphics, values, and/or operands (e.g., AND, OR, NOT, etc.). In some embodiments, the input query is provided automatically in the form of monitored data, such as sensor signals. The input query, in some embodiments, is inferred through behaviors of a user or other contextual information.

In some implementations, one or more input nodes corresponding to the input query are activated (304). The input node(s), in some examples, may have values matching received query tokens (e.g., matching terms and/or numeric inputs submitted), derived from context (e.g., the logged in user's name and/or organization, etc.), and/or extrapolated from received query information (e.g., synonyms, ranges, etc.). The input nodes, for example, may include one or more entities or items (e.g., “axolotl,” “seismic sensor,” “barometric pressure,” etc.), one or more users or individuals (e.g., “County Clinic”, “Dr. Katherine Lake,” “BeepBop Robot Development Group,” etc.), and/or one or more attributes or characteristics (e.g., “50 kilograms,” “78 seconds,” “yellow,” etc.).

In some implementations, an input vector of one or more property value nodes is activated, via each input node, to connect with one or more candidate nodes (306). As described in relation to FIG. 2A and FIG. 2B, for example, the input vector 222 including property value nodes 204a, 204b, and 204c is activated via the input node 202 to connect with candidate nodes 208a and 208b.

In some implementations, one or more cluster weights are calculated for each candidate node reached via activation of each input vector (308). The cluster weight(s), for example, may include a raw cluster weight determined through calculating weights across an activation cluster (e.g., from the input node, to a given activated property value node, and further to each candidate node connected to the given activated property value node). The cluster weight(s) may further include a normalized cluster weight normalizing the raw cluster weight against a maximum score or other base value, and/or an average cluster weight averaged by the number of nodes related to the activated property value node of the activation cluster.

Turning to the example illustrated in FIG. 2A, a set of input connections 212a, 212b, and 212c connect the input resource node 202 to the property value nodes 204a, 204b, and 204c of the input vector 222. In a first activation cluster, the input connection 212a with a weight of 5 connects to the property value node 204a which in turn connects to the candidate resource node 208a via a first connection 214a with a weight of “10” and to the candidate resource node 208b via a second connection 214b with a weight of “20.” The raw weight, in one example, may be calculated by multiplying the input connection weight (e.g., “5”) by the aggregated values of the weights of connections from the property value node to each candidate resource node (e.g., 10+20) to obtain a raw weight of 150. Similarly, in a second activation cluster, the input connection 212b with a weight of “1” connects to property value node 204b, which in turn connects to the first candidate resource node 208a via a first connection 216a having a weight of “2” and connects to the second candidate resource node 208b via a second connection 216b having a weight of “0”. Using the formula described above, the raw weight for the second activation cluster is calculated using the equation 1(2+0)=2. In a generalized manner, the calculation of the raw cluster weight may be described as the sum of all individual products between weight on the activation side and weight on the response (e.g., candidate results) side.

Returning to FIG. 3, in some implementations, if a weight threshold is applied (310), the candidate nodes may be filtered by the weight threshold (312). To avoid providing responses that may contain irrelevant and/or misleading information, a threshold may be applied to suppress recommendations below a set threshold. The weight threshold, in some embodiments, is applied as an organization or end user option. The threshold, for example, may be applied to one or more of the cluster weights (e.g., the raw weight, the normalized weight, the average weight, or a combination of two or more weights). In an illustrative example, a suppression threshold may suppress candidate recommendations from the result list based on having a normalized weight below a set threshold. Suppression thresholds, in a further example, may be applied in combination with further factors (e.g., a particular category of items, etc.) to selectively apply weight thresholds to portions of a set of candidate recommendations.

In some embodiments, one or more weight thresholds are automatically applied based on a context of the input query and/or contextual cues derived from a portion of the neural network activated responsive to the query. Contextual cues, in some examples, can include cues intrinsic to the network (e.g., recent activation history, degree of surrounding activation vs. remote activation, etc.), extrinsic cues received in and/or related to the request such as “side information” (e.g., the local weather, whether the time of day aligns with a particular meal time, etc.), and/or extrinsic cues in the sense of business/application logic (e.g., what is the goal at this point in an encompassing application in which this decision is embedded). The contextual cues, for example, may be used to promote or suppress portions of the candidate results based on automatically derived weight offsets (strengths of influence) of the various cues.

In some implementations, at least one cluster profile is collected for each candidate node (314). The cluster profile may identify matching property value nodes and/or non-matching property value nodes traversed in the course of identifying the topic candidate node. The cluster profile may be captured within the synaptic network-based AI itself such that it is returned as part of the results information (e.g., along with information corresponding to one or more result nodes). The cluster profile may include property value attributes such as, in some examples, a property identifier, a property name, a property value, a property category, a raw weight, an average weight, a normalized weight, and/or a count (e.g., a number of nodes having the same value or, in other words, a number of instances of the property value node). In an illustrative example, the cluster profile may identify the following:

TABLE 1
Example cluster profile.

| | |
|---|---|
| Property ID | 102 |
| Property Name | Dog Breed |
| Property Value | American Eskimo |
| Property Category | Spitz |
| Total Weight | 1.12 |
| Average Weight | 0.112 |
| Count | 4 |

Further, the cluster profile may identify whether the property value node associated with the listed property value attributes was matching or unmatching in the context of the query. In some embodiments, information regarding all matching and unmatching property value nodes is added to the cluster profile, and the profile is later filtered based on end user and/or requestor preferences.

In some embodiments where contextual cues were used to apply a weight, adjust a weight, and/or filter for matching results based on a weight set in part by a contextual cue, the cluster profile includes identification of one or more cues applied in analyzing to the property value node associated with the listed property value. For example, the cluster profile may identify one or more extrinsic cues and/or one or more intrinsic cues, as described above.

In some implementations, the candidate nodes are ranked at least in part by one or more of the cluster weights (316). For example, the candidate nodes may be ranked by the normalized weights of the candidate nodes.

In some implementations, at least a portion of the candidate nodes are selected as one or more result nodes (318). In one example, up to a top threshold of candidate nodes may be returned as result nodes for presentation in response to the query. In another example, one or more filtering parameters may be applied to filter out a portion of the candidate nodes. For example, each of the one or more result nodes may be required to include a minimum count of instances of the given property value and/or have a minimum weight (e.g., normalized, raw, etc.). Further, in some embodiments, certain property values may be excluded from the results. The excluded property results, in some examples, can include exclusions based on similarity (e.g., to remove redundancies or near-redundancies), co-extensiveness with another result (e.g., a more targeted/tighter range of values as opposed to a broader range of values), cross-reference with user preferences and/or other contextual information (e.g., geographic location, recognition of present vehicle travel, time of day, weather, and/or day of the week, etc.), and/or tuning parameters associated with a particular user).

In some implementations, at least a portion of the cluster profile(s) are selected as result reasons information (320). In some examples, the cluster profile(s) may be filtered to exclude properties not included in the result list and/or to exclude properties that are included in the result list. The filtering, for example, may be based at least in part on user and/or group (e.g., enterprise) preference.

Although described as a particular series of operations, in other embodiments, the method 300 may include more or fewer operations. For example, rather than or in addition to applying individual tuning parameters when selecting the one or more result nodes (318), certain tuning parameters may be applied as a pre-query activity, such as adjusting the inputs to the synaptic neural network based on tuning parameters (e.g., to avoid a certain category of results, etc.). In further embodiments, certain operations of the method 300 may be performed in a different order and/or concurrently. For example, the cluster profile(s) may be collected (314) prior to calculating cluster weights (308). Other modifications may be made while remaining within the scope and spirit of the method 300.

The presentation and review of result reasons are described above, for example in relation to FIG. 4A through FIG. 4C. To further improve upon the performance of the synaptic network-based artificial intelligence, in some embodiments, users are provided the opportunity to submit feedback related to the reasons for presenting certain results. The feedback, for example, may relate to the factors that weighed into selecting a particular result, the factors that were not considered in selecting a particular result, and/or factors that were not available for consideration by the AI in making the selection.

Turning to FIG. 5, a flow chart presents an example method 500 for receiving feedback related to reasons for identifying one or more results based on input submitted to a synaptic network-based AI platform. Portions of the method 500, for example, may be performed by the recommendation response engine 148 of FIG. 1.

In some implementations, the method 500 begins with generating a presentation, for review by an end user, of one or more results identified responsive to an input query along with corresponding reasoning regarding factors applied and/or not applied in identifying the one or more results (502). The presentation, for example, may be generated as described in relation to the recommendation organization engine 136, the recommendation reasoning engine 142, and/or the recommendation response engine 148 of FIG. 1. For example, the presentation may be based at least in part on the recommendation(s) 140 and/or the recommendation reason(s) 144 of FIG. 1. The presentation, in some examples, may be similar to the user interface 400 of FIG. 4A or the user interface 410 of FIG. 4C.

In some implementations, at least one mechanism for submitting feedback related to at least one factor is provided in the presentation (504). The feedback submission, for example, may take the form of a feedback control provided in correspondence with the results (or each separate result), such as the feedback control 442 of FIG. 4B. In another example, the feedback may correspond to a manual adjustment of the results list by the user, such as deleting results that are not useful and/or rearranging an order of the results to promote a favored result. In a further example, the feedback may involve selecting one of a set of icons arranged next to each result. In illustration, a user may select a green checkmark to approve of a result or select a red X to disapprove of a result.

Turning to FIG. 4D, in some embodiments, an example user interface 450 for providing feedback related to a result includes a control 452 (e.g., drop-down menu) for selecting one of a set of feedback values. The values, for example, may be textual representations that can be mapped to numeric values. In illustration, the selection “I Like This” may correspond to a +1 numeric value, while the selection “Not a Good Match” may be mapped to a −0.5 numeric value.

Further, in some embodiments, the user interface 450 includes a text entry control 454 for entering a brief statement regarding why or why not the result is a good match. In relation to the subject match of Battlestar Galactica: The Miniseries, the text comment could include statements such as “not a movie,” “runtime too long,” or “main characters not aliens.”

Returning to FIG. 5, in some implementations, if feedback is received (506), the feedback is analyzed to determine whether the end user is satisfied or dissatisfied with the performance of the synaptic neural network (508). The analysis, for example, may include mapping a feedback signal (e.g., selection of an icon, selection from one or more drop-down menu options, etc.) to a numeric value. In the example of the text input control 454 of FIG. 4B, the analysis may include applying a natural language processor (NLP) to parse the feedback statement to determine an appropriate course of action for tuning the synaptic neural network.

In some implementations, if the end user was dissatisfied with subject result (510), one or more adjustment weights are determined to modify the logic flow through the synaptic neural network to better match the desired result(s) of the end user (512). In a first example, weights may be readjusted to reflect a ranked order corresponding to an order of priority of results identified by the end user. In a second example, one or more unlinked nodes may be identified for connection, such that a new path may be forged having a new weight of connection. In a third example, a new node may be created (e.g., a “category node”) for linking similar nodes. The new node, in illustration, may connect substantially identical nodes (e.g., synonyms) into a group representation. Weights between the new node and each node connected to the members of the category node may be produced based at least in part on the strengths of connection between each member node and other node(s). In a fourth example, one or more weights may be reduced based on identifying one or more common factors evident in results deemed unsatisfactory. In illustration, upon analyzing the undesirable results, a common factor of a particular MPAA rating 402e may be evident (e.g., the user is not looking for movies appropriate to small children). Finally, in a fifth example, one or more weights may be adjusted based on identifying one or more common factors evident in results deemed satisfactory. For example, selected results, promoted results, or results actively identified by the user as desirable may be analyzed to identify one or more common factors, such as, in an illustrative example, an MPAA rating 402e of “R.”

In some implementations, the one or more adjustment weights are applied to the synaptic network-based artificial intelligence system (514). In the example of re-ranking results, taking the resultant weights, the strengths of connections between nodes involved in the paths leading to each of the re-ordered results may be adjusted accordingly to modify a synaptic neural network toward the user-identified best answers. In the example of a new connection between existing nodes, the connection may be established and set to the designated weight. In the example of the new category node, the new node may be integrated into the network and links created between the new nodes and the other nodes with the predetermined weights applied to each connection. In this manner, the synaptic neural network can be modified to produce a different (better) result the next time the same or a substantially similar request is posed.

In other embodiments, rather than adjusting weights within the synaptic neural network, weights may be modulated in a user profile of the synaptic network-based artificial intelligence system, such that recommendations may be prioritized (e.g., as described in relation to the recommendation prioritizing engine 120 of FIG. 1) based in part on customized weights stored to the user profile. In this manner, the synaptic neural network itself is unaffected (e.g., other users' experience does not change according to the tuning), but the subject user's experience may be modulated based on their personal feedback. Further to this example, in certain embodiments, the weights applied to the user's profile may be persisted to one or more additional profiles (e.g., a team or group of users) such that the overall synaptic neural network is unaffected, but an organization, working group, social network, or other population of users may benefit from shared network tuning.

In some implementations, the method 500 repeats for each item of feedback received (516).

Although described as a particular series of operations, in other embodiments, the method 500 may include more or fewer operations. For example, although the method 500 illustrates only how negative feedback may be applied in updating the synaptic neural network, in other embodiments, positive feedback may be used to promote or strengthen neural network connections, thereby reinforcing the path taken to reach the match. If the match, for example, was not one of the top matches (e.g., with a confidence score of less than a given threshold, not within a top N results, etc.), the application of reinforcing feedback may increase the likelihood of valid results in the future. Further, as noted above, desirable results may be analyzed to identify one or more common attributes that may be indicative of the user's preferences, such as a preferred setting 402k and/or a preferred MPAA rating 402e. Positive feedback adjustments, for example, may be applied in a manner similar to that which is described in relation to negative feedback adjustments. In further embodiments, certain operations of the method 500 may be performed in a different order and/or concurrently. For example, multiple elements of feedback may be analyzed as a whole (508) to determine the adjustment weights (512) holistically, or at least the updating of the synaptic network-based artificial intelligence system (514) may be postponed until the user has exited the feedback page(s) of the user interface. Other modifications may be made while remaining within the scope and spirit of the method 500.

FIG. 6 illustrates a synaptic network-based artificial intelligence system 600 having a feedback mechanism for applying tuning to a synaptic neural network 602 based on inputs from multiple group members 604, such as a first member 606 connected to the synaptic network-based artificial intelligence system 600 via a remote computing system 608. The synaptic network-based artificial intelligence system 600, for example, may perform portions of the process 100 of FIG. 1, the method 300 of FIG. 3 and/or the method 500 of FIG. 5.

In some implementations, a request 610 (e.g., a query) is submitted via the remote computing system 608 for processing by the synaptic neural network 602. The first group member 606, for example, may submit the request 610. The request 610, in another example, may be automatically submitted by an application executing on the remote computing system 608. The first group member 606, further to this example, may be monitoring output of the application. The request 610, in some examples, may include one or more query terms (e.g., words, data metrics, etc.), identification of the first group member 606, identification of the group the first group member 606 belongs to, and/or contextual data (e.g., corresponding to a portion of the terms, corresponding to the group member's environment, etc.).

In some implementations, the request 610 is received by a query processing engine 612. The request 610, for example, may have been submitted via an application programming interface (API) providing the group members 604 with access to the synaptic neural network 602. The query processing engine 612, for example, may format at least a portion of the information contained in the request 610 for processing by the synaptic neural network 602. In further examples, the query processing engine 612 may validate the first group member 606 and/or the remote computing system 608 with a user validation engine 622 and/or obtain information regarding the first group member 606 and/or the group as a whole from a group members profile data store 624. The query processing engine 612 may supplement information in the request 610 with additional information from the group members profile data store 624.

In some implementations, the query processing engine 612 provides formatted information from the request 610 to a query fulfillment engine 614 for submission to the synaptic neural network 602. The query fulfillment engine 614, for example, may submit the formatted information to the synaptic neural network 602 and log information regarding the submission in a query data log 616.

In some implementations, the query fulfillment engine 614 obtains, responsive to the formatted information from the request 610, one or more results. The query processing engine 612 may format the results as results data 620. Formatting the results data, in some examples, can include post-query processing such as the filtering, screening, and/or prioritizing described in relation to the process 100 of FIG. 1. The results data 620 may include reasons information 618 regarding the reasons for the synaptic neural network 602 recommending particular result(s) in the results data 620. The reasons information 618, for example, may include information such as that described in relation to the recommendation reason(s) 144 of FIG. 1, the reasons table 220 of FIG. 2B, and/or the example cluster profile of Table 1, above.

The query fulfillment engine 614, in some implementations, logs at least a portion of the reasons information 618 to the query log 616 for later reference. The reasons information 618 may be stored, for example, in coordination with at least a portion of the request information 610 and/or additional information (e.g., timestamp, etc.).

In some implementations, the query fulfillment engine 614 provides recommendation(s) and results information to the query processing engine 612 for formatting for use by the remote computing system 608. The query processing engine 612, for example, may format the information in the structure of the API used by the remote computing system 608 for receiving the results information 620.

In some implementations, the remote computing system 608 presents at least a portion of the results information 620 (e.g., one or more recommendations, a portion of the reasons information 618, etc.) for review by the first group member 606. The first group member 606, for example, may be provided with the option of accepting or rejecting each recommendation. The recommendations, in some illustrative examples, may include options for responding to a suspected cybersecurity breach identified via metrics and/or other data included in the request 610, options for disabling or recalibrating part of a processing facility based on worrisome data obtained by a set of industrial internet of things (IIOT) sensors, and/or potential diagnoses of a canine ailment based on patient symptoms and demographics.

The first group member 606, in some implementations, reviews a portion of the reasons information 618 in analyzing whether to accept any or all recommendations provided by the synaptic network-based artificial intelligence system 600. The first group member 606, for example, may review displays such as those described in relation FIG. 4A through FIG. 4C.

In some implementations, the first group member 606 (e.g., information technology (IT) professional, facility management engineer, veterinary professional, etc.), provides feedback 626 related to one or more of the results 620. The feedback 626, in some examples, may include an adjusted priority order of two or more results, a numeric evaluation selected from a scale, a promotion or demotion of an indicated strength of recommendation, a binary (e.g., good/bad) indicator), and/or a word or phrase. The word or phrase, in some examples, may correspond to a numeric scale or be entered by the user as an explanation for satisfaction/dissatisfaction with a particular recommendation.

In some implementations, the user validation engine 622 confirms the identity of the first group member 606 associated with the feedback 626 or otherwise correlates the feedback 626 with the first group member 606. The correlation, for example, may be stored to a feedback log 630 by a feedback processing engine 628.

In some implementations, the feedback processing engine 628 processes the feedback 626 to determine if and/or how to address the feedback 626. In the circumstance of a typed message submitted by the first group member 606, for example, the feedback processing engine 628 may apply natural language processing technique(s) to quantify the meaning of the feedback message (e.g., the subject of node X is not strongly related to the subject of node Y, the subject of node Z does not relate to the input term A of the request 610, etc.). The feedback processing engine 628, in another example, may organize or arrange information from the feedback 626 into a format recognized by a tuning engine 632.

The tuning engine 632, in some implementations, analyzes the formatted feedback information to determine one or more tuning actions to apply. The tuning engine 632, in analyzing the information from feedback 626, may correlate certain information from the feedback 626 with the reasons information 618 of the query log 616. For example, the feedback 626 may include a value (e.g., numeric value, adjusted metric, etc.) corresponding to an identified reason (e.g., activated, unactivated, and/or unmet reason). To quantify the feedback, the tuning engine 632 may require identification of the nodes associated with the reasons corresponding to the information from the feedback 626.

If the feedback 626 relates at least in part to an unmet reason, in some implementations, the tuning engine 632 may determine 634 that there is a data deficit in the synaptic neural network 602 that lead to one or more of the recommendations in the results 620 being inaccurate or misleading. The data deficit, in another example, may have been identified by the first group member 606 in a typed message.

Responsive to determining 634 that there is a data deficit, in some implementations, a learning acquisition engine 636 is tasked with obtaining additional data as learning materials to expand the knowledge base of the synaptic neural network 602. For example, the learning acquisition engine 636 may submit a request for information to one or more group members 604, such as a group leader (e.g., supervisor, manager, etc.) 638. In another example, the learning acquisition engine 636 may identify one or more potential sources for accessing the addition data, such as documentation repositories, web sites, and/or network-accessible databases. The learning acquisition engine 636 may further obtain additional data and format the data for addition to the synaptic neural network 602.

If, instead, no data deficit is determined 634, in some implementations, the tuning engine 632 supplies feedback metrics to a weight adjustment engine 640 for determining one or more adjustments to the synaptic neural network 602. The adjustments, for example, may be determined as described in relation to operation 512 of the method 500 of FIG. 5. The adjustments, for example, may be provided to a network adjustment engine 644 as network adjusting information 642.

In some implementations, the network adjustment engine 644 applies the network adjusting information 642 to updating the synaptic neural network 602. The adjustments, for example, may be applied as described in relation to operation 514 of the method 500 of FIG. 5.

Multiple group members may submit feedback in a similar manner to that described above, resulting in multiple tunings applied to the synaptic neural network 602 by the network adjustment engine 644 and/or multiple information updates to the synaptic neural network 602 by the learning acquisition engine 636. To track the feedback submitted to the synaptic network-based artificial intelligence system 600, in some implementations, a feedback report engine 646 formats data collected in the feedback log 630 into a feedback report 648 for review by the group leader 638. The feedback report 648, for example, may identify the types of feedback submitted and/or propensities for submitting feedback by each of the group members 604.

In some implementations, the feedback report 648 is an interactive report including one or more mechanisms for responding to the applied feedback. In one example, the feedback report 648 may include a feedback mechanism enabling the supervisor 638 to supply feedback to other team members, such as team member 606, regarding their efforts in contributing to the fine tuning of the network 602. In illustration, a feedback mechanism may allow the supervisor 638 to send an encouraging message or congratulations to a top contributor. In another illustration, the supervisor 638 may be enabled, through the feedback report 648, to provide notes to one or more team members regarding supplied feedback, in particular where the feedback may not necessarily comport with the supervisor's view of desirable/undesirable results. Further, in some embodiments, the feedback report 648 includes an override mechanism to override one or more feedback applications to the network 602. For example, upon submitting an override command related to a particular feedback item (e.g., negative feedback related to a particular result), the network adjustment engine 644 may revert weights of the network 602 prior to the application of that feedback item, including any interim adjustments made between present time and that item of feedback (e.g., one or more other items of feedback submitted by the member 606 and/or additional team members). The network adjustment engine 644, further to the example, may re-run the feedback process with the other interim items. In some embodiments, rather than immediately processing user feedback, the feedback may pend for approval by the supervisor 638. In this manner, further to the example, the feedback 626 may be presented by the feedback report engine 646 as pending feedback and, upon approval by the supervisor 638, may be applied by the tuning engine 632, the weight adjustment engine 640, the network adjustment engine 644, and/or the learning acquisition engine 636 after acceptance by the supervisor 638.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 100 of FIG. 1, the method 300 of FIG. 3, and/or the method 500 of FIG. 5.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the recommendation response engine 148 and the requester system 150 of FIG. 1, the remote computing system 608 and the query processing engine 612 and/or the user validation engine 622 of FIG. 6, the supervisor system 638 and the feedback report engine 646 of FIG. 6, and/or the network adjustment engine 644 and/or the query fulfillment engine 614 and the synaptic neural network 602 of FIG. 6.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 4A through FIG. 4D.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. For example, the contents of the recommendation filters 108, the non-recommendable nodes 114, the scoring parameters 122, the formatting parameters 146, the thresholding parameters 130, and/or the output profile parameters 138 of FIG. 1, and/or the reasons information 618, the feedback log 630, and/or the group members data 624 of FIG. 6 may be maintained in a database structure.

The systems described herein may communicate with the cloud computing environment through a secure gateway. In some implementations, the secure gateway includes a database querying interface, such as the Google BigQuery™ platform or Amazon RDS™. The data querying interface, for example, may support access by the recommendation filtering engine 104, the recommendation screening engine 112, the recommendation prioritizing engine 120, the recommendation selection engine 128, the recommendation organization engine 136, and/or the recommendation reasoning engine 142 of FIG. 1, and/or the query fulfillment engine 614, the user validation engine 622, and/or the feedback processing engine 628 of FIG. 6.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as natural language processing operations. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit. In some implementations, the edge server communicates with one or more local

devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the process 100 of FIG. 1, the method 300 of FIG. 3, the method 500 of FIG. 5, and/or the process 600 of FIG. 6 may be configured to be performed in part by an edge server or a device interoperating with an edge server. The device interoperating with the edge server, for example, may share processing functionality with the edge server via one or more APIs implemented by the processes.

While certain embodiments have been described, these embodiments have been presented by way of example only, and are not intended to limit the scope of the present disclosures. Indeed, the novel methods, apparatuses and systems described herein can be embodied in a variety of other forms; furthermore, various omissions, substitutions and changes in the form of the methods, apparatuses and systems described herein can be made without departing from the spirit of the present disclosures. The accompanying claims and their equivalents are intended to cover such forms or modifications as would fall within the scope and spirit of the present disclosures.

What is claimed is:

1. A method for generating reasoning related to request results obtained via a synaptic neural network, the method comprising:
receiving, by synaptic network-based artificial intelligence, a request from a computing device;
by the synaptic network-based artificial intelligence, activating, within the synaptic neural network, an input vector representing one or more attributes related to the request;
by the synaptic network-based artificial intelligence, gathering, responsive to the activating,
candidate information characterizing a plurality of candidate nodes identified by the synaptic neural network, and
reasoning information characterizing at least a portion of a plurality of property value nodes explored by the synaptic neural network in reaching each candidate node of at least a portion of the plurality of candidate nodes, wherein the reasoning information comprises at least one of
a) one or more matched nodal values of the plurality of property value nodes, each matched nodal value representing a value selected, by the synaptic neural network, as being responsive to at least a portion of the input vector, or
b) one or more unmatched nodal values of the plurality of property value nodes, each unmatched nodal value representing a value traversed by the synaptic neural network without selection;
selecting, by the synaptic network-based artificial intelligence, one or more result nodes of the plurality of candidate nodes; and
by the synaptic network-based artificial intelligence, identifying, based at least in part on the one or more result nodes, at least a portion of the reasoning information;
wherein results information representing a nodal value of each result node of the one or more result nodes, and the portion of the reasoning information is formatted for review by an end user of the computing device.

2. The method of claim 1, wherein the reasoning information is collected in at least one cluster profile, each cluster profile identifying, for each respective property value node of at least one property value node of the plurality of property value nodes:
a nodal value of the respective property value node;
at least one categorical identifier corresponding to the nodal value of the respective property value node; and
at least one weight or count representing connections between the respective property value node and one or more additional nodes of the synaptic neural network.

3. The method of claim 1, further comprising:
screening, by the synaptic network-based artificial intelligence, the at least the portion of the plurality of candidate nodes according to one or more screening parameters; and
gathering, by the synaptic network-based artificial intelligence, a screening reasoning information portion of the reasoning information.

4. The method of claim 1, further comprising:
computing, by the synaptic network-based artificial intelligence, a plurality of cluster weights corresponding to at least a subset of the plurality of candidate nodes, wherein the computing comprises, for each respective candidate node of the plurality of candidate nodes,
calculating, for each nodal path traversed to reach the respective candidate node, a respective cluster weight of the plurality of cluster weights;
wherein the one or more result nodes are selected based at least in part on the respective cluster weights of the subset of the plurality of candidate nodes.

5. The method of claim 4, further comprising:
filtering, by the synaptic network-based artificial intelligence, the at least the subset of the plurality of candidate nodes according to at least one weight threshold; and
gathering, by the synaptic network-based artificial intelligence, a filtering reasoning information portion of the reasoning information.

6. The method of claim 4, further comprising:
scoring, by the synaptic network-based artificial intelligence, the at least the subset of the plurality of candidate nodes at least in part by the plurality of cluster weights; and
gathering, by the synaptic network-based artificial intelligence, a scoring reasoning information portion of the reasoning information.

7. The method of claim 1, further comprising providing, by the synaptic network-based artificial intelligence, the results information and the portion of the reasoning information to a separate computing system for the formatting.

8. The method of claim 1, further comprising archiving, by the synaptic network-based artificial intelligence, the reasoning information to a non-volatile computer-readable storage.

9. The method of claim 1, further comprising:
receiving, from the computing device, feedback information related to at least one result node of the one or more result nodes; and
analyzing, by the synaptic network-based artificial intelligence, the feedback information to determine one or more tuning factors to modify the synaptic neural network to better match end user expectations.

10. The method of claim 9, wherein the one or more tuning factors comprise one or more weight adjustments to one or more nodal connections of the synaptic neural network.

11. The method of claim 9, wherein the one or more tuning factors comprise remedying a data deficit of the synaptic neural network.

12. The method of claim 9, further comprising automatically adjusting, by the synaptic network-based artificial intelligence, the synaptic neural network according to the one or more tuning factors.

13. A system for generating reasoning related to request results obtained via a synaptic neural network, the system comprising:
a synaptic neural network system comprising a plurality of nodes interconnected by a plurality of nodal connections, wherein the synaptic neural network system is configured to
gather, responsive to activation via an input vector,
candidate information characterizing a plurality of candidate nodes of the plurality of nodes, and
reasoning information characterizing at least a portion of a plurality of property value nodes explored in traversing a portion of the plurality of nodal connections to reach each candidate node of at least a portion of the plurality of candidate nodes, wherein the reasoning information comprises at least one of
a) one or more matched nodal values of the plurality of property value nodes, each matched nodal value representing a value selected as being responsive to at least a portion of the input vector, or
b) one or more unmatched nodal values of the plurality of property value nodes, each unmatched nodal value representing a value traversed without selection; and
processing circuitry configured to
activate, within the synaptic neural network, the input vector representing one or more attributes related to a request to be performed on behalf of a requestor;
identify one or more result nodes of the plurality of candidate nodes; and
cause presentation of results information representing i) a nodal value of each result node of the one or more result nodes, and ii) at least a portion of the reasoning information for review by an end user of a computing device.

14. The system of claim 13, wherein the requestor is an algorithm configured to automatically submit requests to the system.

15. The system of claim 13, wherein the requestor is a first computing system, and a different computing system than the first computing system comprises the computing device.

16. The system of claim 13, wherein causing the presentation of the results information comprises providing i) the nodal value of each result node of the one or more result nodes, and ii) the at least the portion of the reasoning information to the computing device via an application programming interface (API).

17. The system of claim 13, wherein causing the presentation of the results information comprises generating a visual map representing a plurality of attributes derived from the reasoning information corresponding to the plurality of property value nodes, and one or more values corresponding to each attribute of the plurality of attributes.

18. The system of claim 13, wherein causing the presentation of the results information comprises causing the presentation in an interactive user interface comprising at least one feedback mechanism for submitting, by a user of the computing device, feedback related to at least one result.

19. The system of claim 18, wherein the at least one feedback mechanism comprises a binary feedback mechanism accepting the feedback either approving or disapproving of the at least one result.

20. The system of claim 18, wherein:
a first feedback mechanism of the at least one feedback mechanism is configured to receive a feedback statement; and
the processing circuitry is further configured to analyze, using natural language processing techniques, the feedback statement.
